(19) United States
(12) Patent Application Publication
(10) Pub. No.: US 2012/0098471 A1
(43) Pub. Date: Apr. 26, 2012

(54) ELECTRICAL SYSTEM AND METHOD FOR CONTROLLING AN ELECTRICAL MOTOR

(75) Inventors: Tracy j. Newnam (Deceased), Rockton, IL (US); Charles J. Romenesko, Rockford, IL (US); Mark A. Bertolasi, Belvidere, IL (US); Todd William Hanson, Oregon, WI (US); Jian M. Wu, Rockford, IL (US)

(73) Assignee: Danfoss Drives A/S, Graasten (DK)

(21) Appl. No.: 12/908,571

(22) Filed: Oct. 20, 2010

(51) Int. Cl. H02P 23/00

(52) U.S. Cl. 318/400.09

(57) ABSTRACT

An electrical system comprising an electrical motor and a method for controlling the electrical motor. The system comprises the electrical motor, a power source connection, a first motor control device placed between the power source connection and the motor, and a second motor control device placed in parallel with the first motor control device, the first motor control device supplying electrical power to the motor at least one first operating condition of the motor, and the second motor control device supplying electrical power to the motor at least one second operating condition of the motor, wherein the at least one first operating condition differs from the at least one second operating condition of the motor.

### FIELD OF THE INVENTION

The invention relates to an electrical system comprising an electrical motor, a power source connection and a first motor control device placed between the power source connection and the motor.

Furthermore, the invention relates to a method for controlling an electrical motor by supplying electrical energy to the motor by means of a first motor control device which is placed between the motor and an electrical power source.

### BACKGROUND OF THE INVENTION

One of the simplest ways to control an electrical motor is to use a switch. When the switch is closed the motor is connected to the power source which may be an AC-network with one phase or a plurality of phases.

In many cases a simple switch is not sufficient, in particular when the speed of the motor is to be controlled. In this case a variable frequency drive is placed in the line between the power source and the motor. A variable frequency drive converts the AC-net signal into DC, and then from that DC creates a motor driving output which has a desired frequency. There are many techniques for creating the driving output, e.g. pulse width modulation. In some circumstances it might be an advantage if the variable frequency drive is replaced with a soft starter. A soft starter is often a simpler device than a variable frequency drive and is used to reduce the torque on the motor during the start-up phase and thus reduce stress on the system, or to limit current used while the motor runs up to speed.

A further development has been made by bypassing the variable frequency drive by a direct line. This enables the motor to be driven either directly without control when the bypass is used, or controlled via the variable frequency drive which is less efficient but more controllable.

Examples for a motor which is powered either by a variable frequency drive or directly by the power source via the bypass are disclosed in U.S. Pat. No. 7,272,302 B2, U.S. Pat. No. 6,952,088 B2, U.S. Pat. No. 6,370,888 B1, U.S. Pat. No. 7,081,735 B1 or, U.S. Pat. No. 6,246,207 B1, or U.S. Pat. No. 7,558,031 B2.

However, when the variable frequency drive is bypassed by a line connecting the motor directly to the power source there is no further possibility to control the motor unless the power supply is transferred back to the variable frequency drive. This reduces the control possibilities or makes the variable frequency drive expensive since the variable frequency drive must be able to supply the electrical motor over the full operating range of the motor.

### SUMMARY OF THE INVENTION

It is the object underlying the present invention to improve motor control in an economic manner.

Accordingly, the invention provides an electrical system comprising an electrical motor, a power source connection, a first motor control device placed between the power source connection and the motor, a second motor control device placed in parallel with the first motor control device, the first motor control device supplying electrical power to the motor at least one first operating condition of the motor, and the second motor control device supplying electrical power to the motor at least one second operating condition of the motor, wherein the at least one first operating condition differs from the at least one second operating condition.

Furthermore, the invention provides a method for controlling an electrical motor by supplying electrical energy to the motor by means of a first motor control device which is arranged between the motor and an electrical power source, wherein depending on at least one operating condition of the motor the supply of electrical energy is transferred to a second motor control device which is arranged in parallel with the first motor control device.

According to the invention it is possible to undersize the first motor control device, e.g. the variable frequency drive, because this first motor control needs not to be dimensioned for the full operating range of the motor. This makes the first motor control device less expensive. However, in operating ranges of the motor which are outside of the operating range of the first motor control device control of the motor is performed by means of the second motor control device. Since the second motor control device can be designed and sized also for a smaller operating range of the motor it can be manufactured in an economic way saving costs for the electrical system in total.

Preferably the operating conditions comprise a motor speed. The first motor control device controls the energy supply to the motor until a set speed and transfers control to the second motor control device when the motor reaches the set speed. However, it is also possible that the transfer from the first motor control device to the second motor control device occurs over a range of speeds. In this case it is useful to use a second parameter which determines the transfer from the first motor control device to the second motor control device, for example torque of the motor or harmonic distortion or electromagnetic noise emission of the motor.

The electrical power supplied by the first motor control device can differ from the electrical power supplied by the second motor control device in at least one of frequency, voltage, and current. The parameters of the electrical power can be chosen in order to reach an optimum operating condition of the motor. It is possible that the second motor control device has a smaller range of frequency control than the first motor control device.

Preferably the second motor control device is a solid state circuit. A solid state circuit does not have any mechanical or electro-mechanical devices like switches or contactors. Therefore, the lifetime of the second motor control device can be increased.

In a preferred embodiment the second motor control device comprises an AC/AC-converter. Such a converter is capable of supplying full power to the motor so that it is more efficient than a variable frequency drive at full power or highest frequency. However, in some configurations, such an AC/AC-converter may be able to vary the driving voltage of the motor slightly from the nominal voltage of the motor resulting in a higher slip and reduced speed of an induction motor although with the cost of greater harmonic distortion (with resulting electromagnetic noise generation), since in this case the second motor control device is not as sophisticated as a conventional variable frequency drive which is used as the first motor control device. When an AC/AC-converter is used, a second criterion for transferring the control from the first motor control device to the second motor control device could be the electromagnetic noise or harmonic distortion.

The second motor control device may comprise reverse-parallel-connected silicon-controlled rectifiers, e.g. thyristors. This is a very simple way to realize an AC/AC-converter at relatively low costs.

Preferably the second motor control device functions as fail safe alternative to the first motor control device. Some markets require a “fail safe function” which should guarantee the operation of the electrical motor even in case the first motor control device fails. This can be realized in a low cost manner by using the second motor control device so that the motor can be controlled even if the first motor control device no longer operates.

Preferably the first motor control device and the second motor control device are integrated in the same housing. This is not only a cost saving way to construct the system but also a space saving way.

Furthermore, it is preferable when switching means provided for changing the power supply to the motor from the first motor control device to the second motor control device are in the form of solid state switches. As mentioned above, when solid state switches are used there is no need for having electro-mechanical devices like switches or connectors. The lifetime of the system can be increased and switching noise during operation can be reduced.

In a preferred method the operating condition comprises a speed of the motor. The speed is one of the parameters or operating conditions which can be detected easily. This can be done by one or more dedicated speed sensors, current or voltage sensors in the motor power lines and with or without the use of a motor model. Such sensors and techniques are known in the art.

In a preferred embodiment the transfer from the first motor control device to the second motor control device occurs at a set speed of the motor. In this case the first motor control device controls the motor from a first time when the motor is started to a second time when the motor reaches the predetermined or set speed. A second motor control device takes over control for the set speed or speeds above the set speed, respectively.

Preferably the set speed is a predetermined percentage of the full speed of the motor. Examples for the percentage are 90% or 95% of the full speed of the motor. The specific percentage should be chosen according to the demands of the user.

In an alternative embodiment the set speed is the full speed of the motor. This means that the first motor control device is used to run the motor until it reaches full speed, where, for example, transfer occurs at full nominal speed. However, the first motor control device can still be specified undersized since the length of time at full speed will be short. It will not be required to run continuously at this speed. As soon as the motor reaches its nominal speed the second motor control device will take over control.

Furthermore it is preferable that the transfer occurs depending on at least two operating conditions, wherein the first operation condition comprises a predetermined range of speed and the second operation condition comprises a second parameter. This second parameter can be the noise or harmonic distortion permitted by local regulations or the demands of the user. The second parameter can be as well the torque of the motor or any other parameter.

### BRIEF DESCRIPTION OF THE DRAWINGS

Various other features and advantages of the invention are set forth in the following drawings, description and claims.

FIG. 1 shows a bloc diagram of a system that includes the two motor control devices of the present invention.

FIG. 2 shows schematically more details of the two motor control devices.

### DETAILED DESCRIPTION OF THE PREFERRED EMBODIMENT

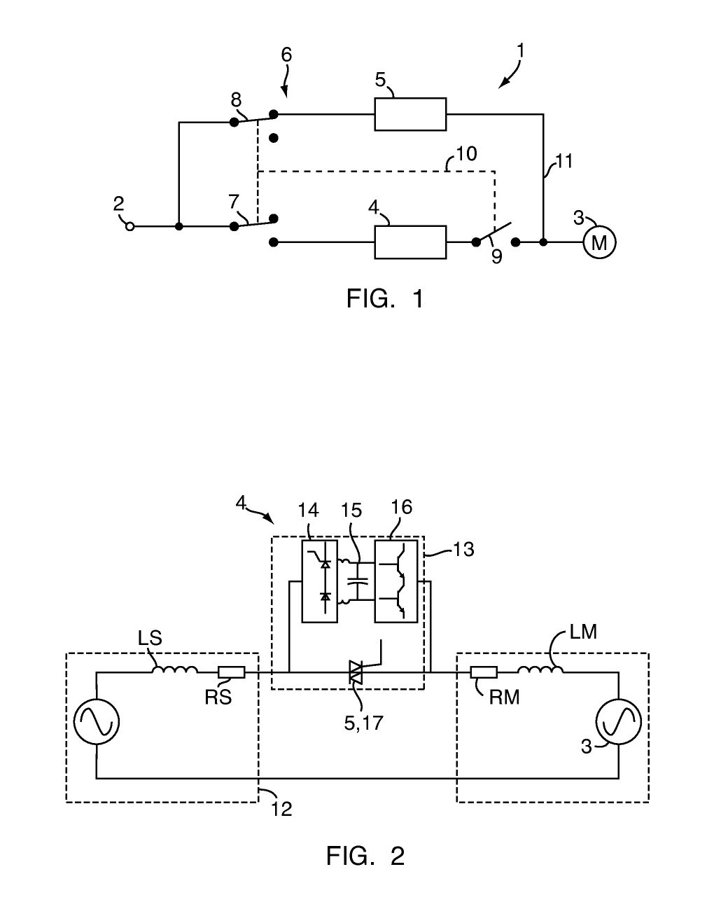

FIG. 1 schematically shows an electrical system 1 comprising a power source connection 2 which can be connected to a grid, a generator or a public power supply network. The connection 2 can be a single phase connection or a multi-phase connection, e.g. a three-phase connection.

The system further comprises an electrical motor 3 which can be an asynchronous or a synchronous motor. Such a motor 3 can be used to drive a fan, an air-conditioning unit, a compressor or the like.

A first motor control device 4 is placed between the power source connection 2 and the motor 3. A second motor control device 5 is placed in parallel with the first motor control device 4. A switch arrangement 6 comprises two switches 7, 8 between the power source connection 2 and the first motor control device 4 and the second motor control device 5, respectively, and a third switch 9 which is placed between the first motor control device 4 and the motor 3. All switches 7-9 can be actuated simultaneously as indicated by the dashed line 10 although this is not necessary. The actuation is controlled by means of a controller which is not further shown. By means of the switches 7, 9 the first motor control device 4 can completely be made free of voltage. The second motor control device 5 arranged in a line 11 parallel to the first motor control device 4 is subjected to the signal at the output of the first motor control device 4. However, it is possible to use a fourth switch (not shown) opening the line 11 when switch 7 is opened.

The switches shown in FIG. 1 are not necessarily operated simultaneously. One mode of operation is to disconnect the first motor control device 4 from the power source and the motor 3 by opening switches 7 and 9, but leaving switch 8 closed. It is also possible to disconnect the first motor control device 4 from the motor 3 by opening switch 9 leaving switches 7 and 8 closed.

The switches 7-9 could be solid state or mechanical.

The switches 7 and 9, for example, could be used to isolate the first motor control device 4 for maintenance whilst the second motor control device 5 is in service. If a fourth switch in line 11 was present then this could be used to isolate the second motor control device 5 in the same way when the first motor control device 4 was in service.

In this example the first motor control device 4 is a variable frequency drive, also known as a frequency converter or inverter. The variable frequency drive converts the AC power source signal into DC, and then from that DC creates a motor driving output which has a desired frequency. An example for creating the driving output is pulse width modulation. The control of the motor via the variable frequency drive is less efficient but more controllable compared to the direct connection of the motor to the power source connection 2. However, the operation of the variable frequency drive requires energy, e.g. for the controlling of electronic switches.

The second motor control device 5 forms a solid state circuit. Such a circuit might comprise a circuit similar to an AC/AC-converter circuit such as reverse-parallel-connected silicon-controlled rectifiers capable of supplying full power to the motor. Such a solid state circuit has the characteristic that it is more efficient than a variable frequency drive at full power or frequency. In some configurations such a solid state circuit may be able to vary the driving voltage of the motor 3 slightly from the nominal voltage of the motor 3 resulting in a higher slip and reduced speed of an induction motor although with the cost of greater harmonic distortion (with resulting electromagnetic noise generation) since the driving circuit of the solid state circuit is not as sophisticated as those used in conventional variable frequency drives.

The second motor control device 5 will also function as a fail safe alternative to the first motor control device 4 where required by the market. In these high reliability cases, additional isolation contactors may be utilised.

Such a configuration can be used in several ways. The variable frequency drive of the first motor control device 4 can be used to start the motor, and transfer to the second motor control device 5 either at full speed, or at a certain percentage of full speed, the actual transfer speed being a function of the wishes of the user of the equipment, or electromagnetic noise (harmonic distortion) permitted by local regulations.

The first motor control device 4 can use one or more of the following variable speed drives: voltage source inverter (as shown in FIG. 2), active front end voltage source inverter, current source inverter, matrix converter, Z-source inverter and multi-level inverter. All these topologies are well known per se.

One important advantage of this configuration is that the variable frequency drive of the first motor control device 4 can be designed with a specification less than that required to run the motor at full speed or full torque. In other words, the first motor control device 4 can be undersized. This is because the variable frequency drive will not be required to run the motor 3 at full nominal speed since it will transfer to the second motor control device 5 at some speed which is lower than the full speed, for example 90% or 95%. In some configurations, however, it still may be required to run the motor 3 at full nominal speed (where, for example, transfer occurs at full nominal speed) but the first motor control device 4 can still be specified undersized since the length of time at full speed will be short. It will not be required to run continuously at the speed. As soon as full speed of the motor drive 3 has been reached the second motor control device 5 takes over control.

The switches 7-9 can be made as solid state switches, i.e. they work without electro-mechanical devices which are prone to wear out through normal use. The second motor control device 5 can also be a solid state bypass circuit without any electro-mechanical devices.

The second motor control device 5 in the line 11 can be used in the following ways:

A full size variable frequency drive in the first motor control device 4 can be used. Control is transferred to the second motor control device 5 at full frequency, e.g. 60 Hz or 50 Hz. There is no speed control in the second motor control device 5 and insignificant harmonic distortion when compared with the variable frequency drive which generates such distortion through the use of switching, such as in the use of pulse width modulation techniques.

In another embodiment, an undersized variable frequency drive (e.g. 75% of the nominal motor power) is used in the first motor control device 4 and a solid state second motor control device 5. The first motor control device 4 is run temporarily above its nominal rating to perform the transfer at full speed. There is no speed control when the motor is being driven by the second motor control device 4, but insignificant harmonic distortion when compared with the variable frequency drive for the reasons described above.

In a further embodiment, an undersized variable frequency drive is used in the first motor control device 4 which has only 60% to 75% of the nominal power. Transfer to the second motor control device 5 occurs at 60 Hz or 50 Hz, respectively, depending on the power source frequency. The variable frequency drive in this case can be thermally supervised in order to avoid an overheating. At full speed or a too high temperature, control is taken over by the second motor control device 5. The second motor control device 5 does not perform any speed control, however, it operates with reduced harmonic distortion when compared with the variable frequency drive for the reasons described above.

In a further embodiment, the second motor circuit offers speed control between 52 through 60 Hz or 43 through 52 Hz, respectively, for example by varying the supply voltage to an asynchronous motor. Harmonic distortion increases as voltage decreases.

In yet another further embodiment, an undersized variable frequency drive is used in the first motor control device 4 and to transfer to 11 between 52 trough 60 Hz or 43 through 50 Hz, respectively. The second motor control device 5 offers speed control between 52 through 60 Hz or 43 through 50 Hz, respectively, for example by varying the supply voltage to an asynchronous motor. Harmonic distortion increases as voltage decreases. The harmonic distortion can be a criterion for transferring the motor control from the first motor control device 4 to second motor control device 5.

In another embodiment, a generator is used as voltage source instead of a, for example, a public power supply network. Such a generator might produce a voltage with a frequency other than 50 Hz or 60 Hz. When another frequency is used, control is transferred between 85% and 100% of this frequency. The same is true for grids or other voltage sources having frequencies other than 50 Hz or 60 Hz.

FIG. 2 shows further details. The motor 3 is connected to a power supply 12 having an impedance LS, RS. The motor 3 is illustrated having a motor impedance LM, RM.

Both motor control devices 4, 5 (the same numerals are used for the same elements throughout the description) are arranged in a common housing 13.

The first motor control device 4 comprises a full wave rectifier 14, a DC-intermediate circuit 15 and an inverter 16 producing AC from the DC of the intermediate circuit 15.

The second motor control device 5 comprises reverse-parallel-connected silicon-controlled rectifiers 17 like thyristors. No mechanical switches are necessary.

As described above a criterion for changing over the control from the first motor control device 4 to the second motor control device 5 is an operating condition of the motor 3, in particular the speed of a motor 3. When the control is transferred from the first motor control device 4 to the second motor control device 5 the electrical power supplied to the motor 3 can slightly be changed in the parameters frequency, voltage, and current. However, the first motor control device 4 and the second motor control device 5 are adapted to each other so that a smooth transition is secured.

While the present invention has been illustrated and described with respect to a particular embodiment thereof, it should be appreciated by those of ordinary skill in the art that various modifications to this invention may be made without departing from the spirit and scope of the present.

What is claimed is:

1. An electrical system comprising an electrical motor, a power source connection, a first motor control device placed between the power source connection and the motor, and a second motor control device placed in parallel with the first motor control device, the first motor control device supplying electrical power to the motor at least one first operating condition of the motor and the second motor control device supplying electrical power to the motor at least one second operating condition of the motor, wherein the at least one first operating condition differs from the at least one second operating condition of the motor.

2. The system according to claim 1, wherein the operating conditions comprise a motor speed.

3. The system according to claim 1, wherein the electrical power supplied by the first motor control device differs from the electrical power supplied by the second motor control device in at least one of frequency, voltage, and current.

4. The system according to claim 1, wherein the second motor control device is a solid state bypass circuit.

5. The system according to claim 1, wherein the second motor control device comprises an AC/AC-converter.

6. The system according to claim 1, wherein the second motor control device comprises reverse-parallel-connected silicon-controlled rectifiers.

7. The system according to claim 1, wherein the second motor control device functions as fail safe alternative to the first motor control device.

8. The system according to claim 1, wherein the first motor control device and the second motor control device are integrated in the same housing.

9. The system according to claim 1, wherein switching means provided for changing the power supply to the motor from the first motor control device to the second motor control device are in the form of solid state switches.

10. A method for controlling an electrical motor by supplying electrical energy to the motor by means of a first motor control device which is placed between the motor and an electrical power source wherein depending on at least one operating condition of the motor the supply of electrical energy is transferred to the second motor control device which is arranged in parallel with the first motor control device.

11. The method according to claim 10, wherein the operating condition comprises a speed of the motor.

12. The method according to claim 11, wherein the transfer from the first motor control device to the second motor control device occurs at a set speed of the motor.

13. The method according to claim 12, wherein the set speed is a predetermined percentage of the full speed of the motor.

14. The method according to claim 12, wherein the set speed is the full speed of the motor.

15. The method according to claim 10, wherein the transfer occurs depending on at least two operating conditions, wherein the first operation condition comprises a predetermined range of speed and the second operation condition comprises a second parameter.
